(19) United States
(12) Patent Application Publication
(10) Pub. No.: US 2016/0098302 A1
(43) Pub. Date: Apr. 7, 2016

(54) RESILIENT POST-COPY LIVE MIGRATION USING EVICTION TO SHARED STORAGE IN A GLOBAL MEMORY ARCHITECTURE

(71) Applicant: Strato Scale Ltd., Herzlia, IL (US)

(72) Inventors: Muli Ben-Yehuda, Haifa (IL); Rom Frieman, Givatayim (IL); Abel Gordon, Haifa (IL); Benoit Hudzia, Belfast (GB); Maor Vanmak, Magal (IL)

(21) Appl. No.: 14/588,424

(22) Filed: Jan. 1, 2015

Related U.S. Application Data
(60) Provisional application No. 62/060,593, filed on Oct. 7, 2014.
(60) Provisional application No. 62/060,594, filed on Oct. 7, 2014.

(51) Int. Cl. G06F 9/50; G06F 9/455; G06F 9/48

(52) U.S. Cl. CPC G06F 9/5088; G06F 9/4881; G06F 9/45558; G06F 2009/4557

(57) ABSTRACT

A method includes, in a computing system that includes at least first and second compute nodes, running on the first compute node a workload that uses memory pages. The memory pages used by the workload are classified into at least active pages and inactive pages, and the inactive memory pages are evicted to shared storage that is accessible at least to the first and second compute nodes. In response to migration of the workload from the first compute node to the second compute node, the active pages are transferred from the first compute node to the second compute node for use by the migrated workload, and the migrated workload is provided with access to the inactive pages on the shared storage.

### CROSS-REFERENCE TO RELATED APPLICATIONS

This application claims the benefit of U.S. Provisional Patent Application 62/060,593, filed Oct. 7, 2014, and U.S. Provisional Patent Application 62/060,594, filed Oct. 7, 2014, whose disclosures are incorporated herein by reference.

### FIELD OF THE INVENTION

The present invention relates generally to computing systems, and particularly to methods and systems for live migration of workloads.

### SUMMARY OF THE INVENTION

An embodiment of the present invention that is described herein provides a method including, in a computing system that includes at least first and second compute nodes, running on the first compute node a workload that uses memory pages. The memory pages used by the workload are classified into at least active pages and inactive pages, and the inactive memory pages are evicted to shared storage that is accessible at least to the first and second compute nodes. In response to migration of the workload from the first compute node to the second compute node, the active pages are transferred from the first compute node to the second compute node for use by the migrated workload, and the migrated workload is provided with access to the inactive pages on the shared storage.

In some embodiments, the workload includes one of a Virtual Machine (VM) and an operating-system container. Typically, a failure domain of the workload consists of a single compute node at all times, except for a time interval following the migration during which the failure domain includes the first and second compute nodes.

In some embodiments, evicting the inactive pages includes running a process that evicts at least some of the inactive pages prior to the migration, and, in response to the migration, identifying any remaining inactive pages on the first compute node and evicting the identified inactive pages to the shared storage. In an embodiment, evicting the inactive pages includes assigning to the workload a logical volume on the shared storage, and writing the inactive pages to the logical volume. In another embodiment, the method includes maintaining a data structure that indicates, for each memory page used by the workload, whether the memory page is valid on the shared storage.

In some embodiments, evicting the inactive pages includes detecting that multiple workloads on the first compute node use respective inactive pages having a same content, and writing to the shared storage multiple respective copies of the same content for use by the respective workloads.

In some embodiments, evicting the inactive pages includes detecting that a plurality of the inactive pages used by the workload have a same content, selecting one of the inactive pages in the plurality, and writing only the selected inactive page to the shared storage. Providing access to the inactive pages may include, in response to a request to access one of the inactive pages in the plurality other than the selected inactive page, serving the same content by accessing the selected inactive page.

In yet another embodiment, the method includes maintaining a single-bit indication of whether all the memory pages used by the workload have been evicted from the first compute node. In still another embodiment, evicting the inactive pages includes producing multiple replicas of at least some of the evicted inactive pages, and storing the replicas on respective different storage devices as part of the shared storage.

There is additionally provided, in accordance with an embodiment of the present invention, a computing system including at least first and second compute nodes, and shared storage that is accessible at least to the first and second compute nodes. The first compute node is configured to run a workload that uses memory pages, to classify the memory pages used by the workload into at least active pages and inactive pages, and to evict the inactive memory pages to the shared storage. In response to migration of the workload from the first compute node to the second compute node, the first and second compute nodes are configured to transfer the active pages from the first compute node to the second compute node for use by the migrated workload, and to provide the migrated workload access to the inactive pages on the shared storage.

There is further provided, in accordance with an embodiment of the present invention, a computer software product, the product including a tangible non-transitory computer-readable medium in which program instructions are stored, which instructions, when read by processors of first and second compute nodes, cause the processors to run on the first compute node a workload that uses memory pages, to classify the memory pages used by the workload into at least active pages and inactive pages, to evict the inactive memory pages to shared storage that is accessible at least to the first and second compute nodes, and, in response to migration of the workload from the first compute node to the second compute node, to transfer the active pages from the first compute node to the second compute node for use by the migrated workload, and to provide the migrated workload access to the inactive pages on the shared storage.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a compute-node cluster, in accordance with an embodiment of the present invention;

FIG. 2 is a diagram that schematically illustrates a global memory architecture used in a compute-node cluster, in accordance with an embodiment of the present invention; and

FIG. 3 is a flow chart that schematically illustrates a method for resilient post-copy live migration of a Virtual Machine (VM), in accordance with an embodiment of the present invention.

### DETAILED DESCRIPTION OF EMBODIMENTS

### Overview

Embodiments of the present invention that are described herein provide improved methods and systems for migration of workloads between compute nodes in a compute-node cluster. The embodiments described herein refer mainly to Virtual Machines (VMs) and VM migration, but the disclosed techniques can be used for migration of other suitable kinds of workloads, such as operating-system containers.

In some embodiments, a VM is to be migrated from a source node to a destination node using post-copy live migration, in which the VM starts running on the destination node before its memory pages are transferred. Unless suitable measures are taken, the failure domain of the VM after migration comprises at least the source node and the destination node. If memory pages of the VM have been evicted to additional nodes in the cluster, the failure domain will comprise these additional nodes, as well.

In order to reduce the vulnerability of the migration process to node failures, the source node classifies the memory pages used by the VM into active pages and inactive pages, and evicts the inactive pages to shared storage. The shared storage comprises some guaranteed storage medium that is accessible at least to both the source node and the destination node.

The source node may generally evict inactive pages to shared storage before or after migration, and typically performs both. In a typical embodiment, the source node runs a background process that identifies inactive pages and evicts them to the shared storage, in preparation for possible migration. Thus, when migration occurs, the pages remaining on the source node comprise the active pages, plus a relatively small number of inactive pages that were not evicted for various reasons. The source node evicts the remaining inactive pages to the shared storage immediately upon migration.

When using the above process, the failure domain of the VM comprises only a single node (the source node or the destination node), except for a short vulnerability interval during which the failure domain consists of both the source node and the destination node. Since the shared storage is assumed to be guaranteed, pages that have been evicted to shared storage do not affect the failure domain or the vulnerability interval.

Before migration, the failure domain includes only the source node. The vulnerability interval begins when the VM is migrated and ends when (1) all active pages have been transferred from the source node to the destination node, and (2) all remaining inactive pages have been evicted from the source node to the shared storage. After these two conditions are met, the failure domain includes only the destination node.

Let T1 denote the time the migrated VM takes to access all its active pages, and thus to have them paged-in from the source node. Let T2 denote the time needed for evicting the remaining inactive pages to the shared storage. Since both processes occur in parallel, the size of the vulnerability interval is max(T1,T2).

Several implementation examples for the resilient post-copy migration technique are described herein. In an example implementation, memory pages are distributed across the cluster using a global memory architecture that enables each workload to utilize the overall memory resources of the entire cluster.

### System Description

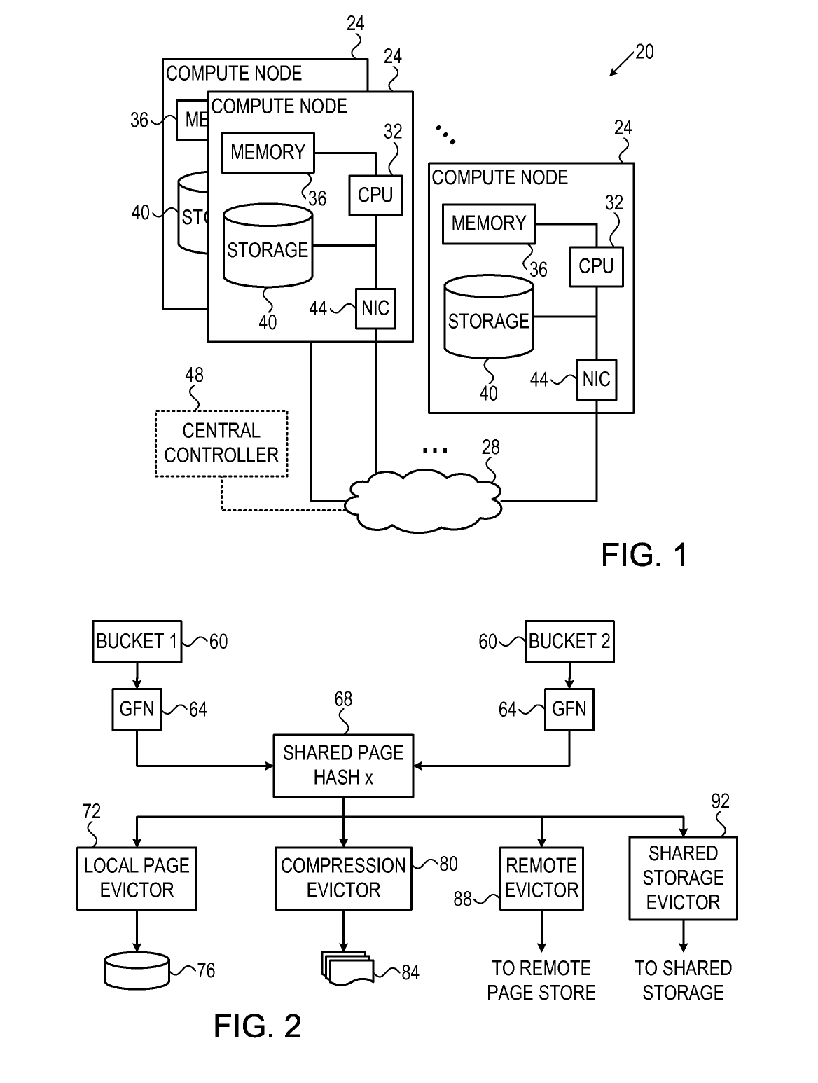

FIG. 1 is a block diagram that schematically illustrates a computing system 20, which comprises a cluster of multiple compute nodes 24, in accordance with an embodiment of the present invention. System 20 may comprise, for example, a data center, a cloud computing system, a High-Performance Computing (HPC) system or any other suitable system.

Compute nodes 24 (referred to simply as “nodes” for brevity) typically comprise servers, but may alternatively comprise any other suitable type of compute nodes. System 20 may comprise any suitable number of nodes, either of the same type or of different types. Nodes 24 are connected by a communication network 28, typically a Local Area Network (LAN). Network 28 may operate in accordance with any suitable network protocol, such as Ethernet or Infiniband.

Each node 24 comprises a Central Processing Unit (CPU) 32. Depending on the type of compute node, CPU 32 may comprise multiple processing cores and/or multiple Integrated Circuits (ICs). Regardless of the specific node configuration, the processing circuitry of the node as a whole is regarded herein as the node CPU. Each node further comprises a memory 36 (typically a volatile memory such as Dynamic Random Access Memory—DRAM) and a Network Interface Card (NIC) 44 for communicating with network 28. Some of nodes 24 (but not necessarily all nodes) comprise one or more non-volatile storage devices (e.g., magnetic Hard Disk Drives—HDDs—or Solid State Drives—SSDs). Storage devices 40 are also referred to herein as physical disks or simply disks for brevity.

In some embodiments, a central controller 48 carries out centralized management tasks for the cluster. Generally, however, central controller 48 is optional. The disclosed techniques can be implemented in a fully distributed manner without any centralized entity.

The system and compute-node configurations shown in FIG. 1 are example configurations that are chosen purely for the sake of conceptual clarity. In alternative embodiments, any other suitable system and/or node configuration can be used. The various elements of system 20, and in particular the elements of nodes 24, may be implemented using hardware/firmware, such as in one or more Application-Specific Integrated Circuit (ASICs) or Field-Programmable Gate Array (FPGAs). Alternatively, some system or node elements, e.g., CPUs 32, may be implemented in software or using a combination of hardware/firmware and software elements. In some embodiments, CPUs 32 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Global Memory Architecture

Nodes 24 typically run workloads, such as Virtual Machines (VMs), processes or containers. The embodiments described herein and the description below refer mainly to VMs, for the sake of clarity. The methods and systems described herein can be used, however, with any other suitable type of workload that accesses memory.

FIG. 2 is a diagram that schematically illustrates a global memory architecture used in system 20, in accordance with an embodiment of the present invention. In this global architecture, a VM on a given node 24 is not limited to use only the (volatile and persistent) memory of that node, but is able to utilize the (volatile and persistent) memory resources of the entire node cluster. The figure shows the main data structures and modules implemented on a given node 24. In an embodiment, the scheme of FIG. 2 is implemented on the hypervisor of each node 24 for providing memory access to the VMs running on the node.

In the present example, the hypervisor maintains a respective bucket 60 per VM. The bucket points to Guest Frame Numbers (GFNs) 64 of memory pages used by the respective VM. The GFNs specify addresses in the memory space of the guest VM. In practice, different VMs may use different GFNs that point to the same content. Thus, each GFN points to an appropriate entry in a shared page data structure 68. Each entry in the shared page data structure points to a shared page. A shared page comprises a page-sized content item, which is identified by a hash value computed over its content.

A given shared page may be physically stored in any of multiple locations:
Resident in the local volatile memory of the same node.
Evicted to local persistent storage 76 (non-volatile memory) of the same node by a local page evictor 72.
Evicted in compressed form to a local compressed memory 84 by a compression evictor 80.
Evicted to a remote node 24 in system 20 by a remote evictor 88. On the remote node, the shared page may be stored in volatile memory, in persistent storage or in compressed memory.
Evicted to shared storage by a remote-storage evictor 92.

When a VM requests a memory page, the hypervisor fetches the appropriate content from its local or remote location in accordance with shared page data structure 68. The VM is typically unaware of the actual physical storage location of the content.

The memory management configuration shown in FIG. 2 is an example configuration that is depicted purely for the sake of conceptual clarity. In alternative embodiments, the global memory architecture may be implemented in any other suitable way.

### Resilient Post-Copy Live Migration

In some embodiments, system 20 migrates a VM (or other workload) from one compute node 24 to another, e.g., in response to an instruction from controller 48. The former node is referred to herein as a source node, and the latter node is referred to herein as a destination node. In some disclosed embodiments, system 20 carries out a resilient migration process that reduces the vulnerability of the VM to node failures.

The migration process described herein is live, i.e., performed while the VM is running. The process is defined as “post-copy” since the memory pages used by the VM are transferred (or otherwise made accessible to the VM) after the runtime state of the VM has been migrated and the VM started running on the destination node.

In some embodiments, the VM in question accesses memory pages that are stored in accordance with the global memory architecture described above. In such an architecture, over the lifetime of a VM, memory pages of the VM may be evicted or left behind after migration on any of the nodes in the cluster. Therefore, unless measures are taken, the failure domain of the VM may grow to become the entire cluster, or at least a large number of nodes. In other words, unless measures are taken, a failure in any of a large number of nodes may cause the VM to fail.

The migration scheme described herein confines the failure domain of each VM to a single node (the source or the destination), except for a small time interval during which the failure domain comprises both the source node and the destination node.

In some embodiments, the disclosed technique assumes that shared storage is available and that memory pages can be evicted to shared storage as desired. In the present context, the term “shared storage” means storage that is accessible at least to both the source node and the destination node. Typically, the shared storage is accessible to any node that hosted the VM in the past, currently hosts the VM, or may host the VM in the future. The shared storage is typically resilient, or guaranteed, e.g., using replication or other suitable means.

Shared storage can be implemented in various ways, such as using an external Network Attached Storage (NAS) or Storage Attached Network (SAN). In another embodiment, shared storage may be implemented using a storage scheme that distributes replicated copies of pages across the existing (volatile and persistent) memory resources of compute nodes 24. Distributed storage schemes of this sort are described, for example, in U.S. patent application Ser. Nos. 14/181,791, 14/260,304, 14/341,813 and 14/333,521, which are assigned to the assignee of the present patent application and whose disclosures are incorporated herein by reference.

The memory pages used by a given VM can be classified as either active (accessed frequently by the VM) or inactive (accessed rarely if at all). In some embodiments, the hypervisor on the source node runs a background process that identifies inactive pages and evicts them to the shared storage. Since the evicted pages are inactive, evicting them from the source node has little or no effect on the VM performance. If the VM is migrated, these pages can be accessed and paged-in by the destination node if necessary. Since the shared storage is guaranteed, the inactive pages stored on it do not extend the failure domain of the VM.

When using such a background process, the memory pages remaining on the source node comprise (1) active pages and (2) inactive pages that for some reason have not been evicted. Inactive pages may remain on the source node, for example, because the hypervisor did not yet classify them as inactive or did not yet evict them, or for any other reason. In some embodiments, the hypervisor of the source node evicts the remaining inactive pages to the remote storage immediately upon migrating the VM to the destination node.

As can be seen from the description above, the failure domain of the VM is confined to a single node, except for a short time interval during which the failure domain comprises both the source node and the destination node. This time interval is referred to herein as the vulnerability interval.

The vulnerability interval ends when two conditions are met: (1) the VM running on the destination node has accessed all its active pages and thus causes them to be paged-in from the source node to the destination node; and (2) all inactive pages remaining on the source node have been evicted to the shared storage. Thus, the size of the vulnerability interval is given by max(T1,T2), wherein T1 denotes the time period that the VM takes to access all its active pages, and T2 denotes the time period needed for evicting the remaining inactive pages from the source node to the shared storage.

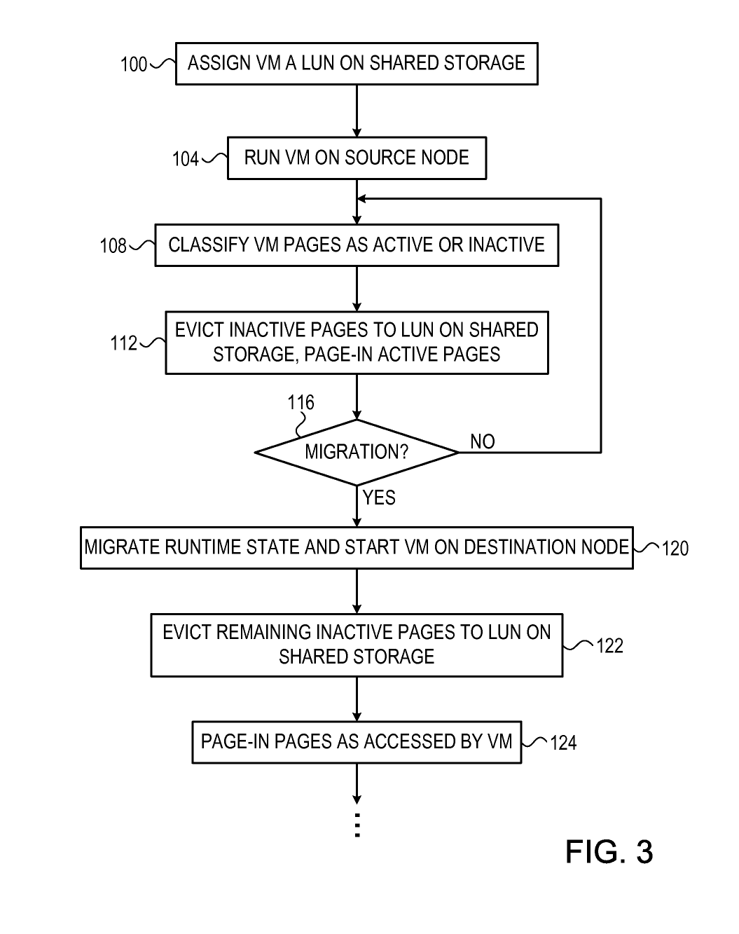

FIG. 3 is a flow chart that schematically illustrates a method for resilient post-copy live migration of a VM, in accordance with an embodiment of the present invention. As noted above, the description herein refers to VM migration, but the disclosed technique can be used for resilient migration of any other suitable workload. A similar process is typically performed per VM.

The method begins with system 20 (e.g., controller 48) assigning a dedicated logical volume on the shared storage to a given VM, at an assignment step 100. The logical volume is identified by a respective Logical Unit Number (LUN). As noted above, the dedicated logical volume is typically accessible to any node that hosted the VM in the past, currently hosts the VM, or may host the VM in the future. The VM initially runs on a certain source node, at a node running step 104.

While the VM is running, the hypervisor of the source node classifies the memory pages used by the VM into active pages and inactive pages, at a classification step 108. The hypervisor evicts inactive pages to the dedicated LUN on the shared storage, and pages-in active pages to the source node if necessary, at an eviction & page-in step 112. As long as no migration occurs, the method loops back to step 108 above.

At this stage, the failure domain of the VM comprises only the source node: The active pages are available locally on the destination node, and inactive pages are either available locally or have been evicted to the shared storage.

When the VM migrates, as detected at a migration checking step 116, the hypervisors of the source and destination nodes transfer the runtime state of the VM to the destination node and resume the VM on the destination node, at a migration step 120. Immediately upon migration, the hypervisor of the source node evicts any remaining inactive pages of the VM from the source node to the dedicated LUN on the shared storage, at an eviction step 122.

In some embodiments, the hypervisor of the destination node pages-in memory pages as they are accessed by the VM, at a page-in step 124. The hypervisor of the destination node may also page-in active pages proactively, i.e., without waiting for the VM to access them. Paged-in pages may comprise active pages that are paged-in from the source node, and/or inactive pages that are paged-in from the shared storage. In an embodiment, the hypervisor of the source node may also actively send active pages to the destination node, possibly before they are accessed by the VM on the destination node or pre-fetched by the hypervisor of the destination node. Steps 122 and 124 are typically performed in parallel.

During the vulnerability interval (until step 122 is completed and until all active pages have been paged-in from the source node at step 124) the failure domain of the VM comprises both the source node and the destination node. As noted above, eviction of inactive pages takes T2 seconds, paging-in of active pages takes T1 seconds, and therefore the vulnerability interval ends after max(T1,T2) seconds from migration.

From this point onwards, the failure domain comprises only the destination node: The active pages are available locally on the destination node, the inactive pages have been evicted to the shared storage and no inactive pages remain on the source node. (Note that some of the inactive pages of the VM may have already been evicted to the shared storage by another node that the VM previously ran on, possibly before the current migration began.) At this stage the VM instance on the source node can be discarded.

As noted above, in some embodiments active pages are paged-in to the destination node when the VM accesses them. In these embodiments, T1 is a typical value that is not unconditionally upper-bounded. In other embodiments, an additional process proactively transfers active pages from the source node to the destination node. Such a process may comprise a “push” process in the source node and/or a “pull” process in the destination node. In these embodiments it is possible to set an upper bound on T1.

In practice, it is possible that one or more of the VM memory pages have never been allocated. In some embodiments, such pages are not classified as active or inactive, but as unallocated. There is generally no need to evict or page-in unallocated memory pages—The destination node would typically allocate them when they are first accessed by the VM. In some embodiments, the hypervisor of the source node indicates to the hypervisor of the destination node which memory pages of the VM have never been allocated. This information may be transferred, for example, as part of the VM metadata.

### Example Implementation

In an example embodiment, the VM pages comprise shared pages in accordance with the global memory architecture of FIG. 2 above. In the dedicated LUN (a shared block device) there is one-to-one mapping that identifies GFNs with block numbers. Both data units are 4 KB in size in this example, although other suitable sizes can also be used. Moreover, the data-unit size is not necessarily a single fixed value, e.g., the system may intermix two or more data-unit sizes.

Each VM maintains a data structure that indicates, for each GFN, whether this GFN is valid on the shared storage (in the dedicated LUN) or not. In the present example the data structure comprises a bitmap having a bit per GFN. A “1” bit value indicates that the respective GFN is valid on the shared storage, and “0” indicates otherwise. Alternatively, any other suitable data structure or convention can be used.

### Eviction of Inactive Pages

Eviction of an inactive page by the hypervisor of the source node (in steps 112 and 122 of FIG. 3) is performed as follows. If the page in question is marked in the bitmap as valid on the shared storage, the hypervisor simply unmaps the page.

Otherwise, the hypervisor writes the page data, e.g., Host Frame Number (HFN) content, to the dedicated LUN of every VM that uses a copy of this page. In other words, if the same HFN is shared by multiple GFNs of multiple respective VMs on the source node, the hypervisor writes the HFN content multiple times, one write per LUN.

When the same content corresponds to multiple GFNs in the same VM, the hypervisor may select only one of these GFNs using some predefined convention, and write only the selected GFN to the dedicated LUN. In the present example, the hypervisor writes only the smallest GFN, although any other suitable convention may be used. The same convention will be used by the hypervisor on the destination node when paging-in these GFNs. The hypervisor of the source node then marks all the evicted GFNs as valid on the shared storage, and unmaps the page.

### Page-in Process

After migration, paging-in of an inactive page from the shared storage (part of step 124 of FIG. 3) is performed as follows. The hypervisor of the destination node reads the page content from the smallest GFN (or any other convention being used) of any of the dedicated LUNs of the VMs that previously mapped this page. The metadata enabling this readout is typically kept in memory.

The hypervisor then maps the page as protected, and also sets the bit indicating that the data is valid on the shared storage. Note that each Copy-on-Write (COW) will create a new shared page that is marked as not valid on the shared storage.

### Migration

As part of migrating the VM, the hypervisors of the source and destination nodes perform the following. The shared-page metadata (e.g., the bitmap indicating which GFNs are valid on the shared storage) is transferred as part of the migration process. Therefore, the hypervisor of the destination node can distinguish between pages that should be paged-in from the volatile memory of the source node, and pages that should be paged-in from the shared storage.

In some practical scenarios, the destination node may request a certain page while the source node is in the process of evicting it to the shared storage. In various embodiments, the source node handles such a request in different ways. For example, the source node may decline the request. In another embodiment, the source node may serve the requested page to the destination node. In yet another embodiment, the source node may direct the destination node to obtain the page from the shared storage.

In some embodiments, in addition to the above-described bitmap, the VM metadata comprises an indication (e.g., flag) of whether all the memory pages pertaining to the VM were evicted from the source node or not. This indication can be used, for example, to decide whether to delete the VM in case of failure in the source node. Without this bit, it may be necessary to scan the entire bitmap for this purpose.

Although the embodiments described herein mainly address workload migration, the methods and systems described herein can also be used in other applications, such as in workload cloning processes that create a copy of a workload (e.g., VM) on a different node, or in Copy-on-Write and thin provisioning mechanisms.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a computing system that comprises at least first and second compute nodes, running on the first compute node a workload that uses memory pages;
classifying the memory pages used by the workload into at least active pages and inactive pages, and evicting the inactive memory pages to shared storage that is accessible at least to the first and second compute nodes; and
in response to migration of the workload from the first compute node to the second compute node,
transferring the active pages from the first compute node to the second compute node for use by the migrated workload, and providing the migrated workload access to the inactive pages on the shared storage.

2. The method according to claim 1, wherein the workload comprises one of a Virtual Machine (VM) and an operating-system container.

3. The method according to claim 1, wherein a failure domain of the workload consists of a single compute node at all times, except for a time interval following the migration during which the failure domain comprises the first and second compute nodes.

4. The method according to claim 1, wherein evicting the inactive pages comprises running a process that evicts at least some of the inactive pages prior to the migration, and, in response to the migration, identifying any remaining inactive pages on the first compute node and evicting the identified inactive pages to the shared storage.

5. The method according to claim 1, wherein evicting the inactive pages comprises assigning to the workload a logical volume on the shared storage, and writing the inactive pages to the logical volume.

6. The method according to claim 1, and comprising maintaining a data structure that indicates, for each memory page used by the workload, whether the memory page is valid on the shared storage.

7. The method according to claim 1, wherein evicting the inactive pages comprises detecting that multiple workloads on the first compute node use respective inactive pages having a same content, and writing to the shared storage multiple respective copies of the same content for use by the respective workloads.

8. The method according to claim 1, wherein evicting the inactive pages comprises detecting that a plurality of the inactive pages used by the workload have a same content, selecting one of the inactive pages in the plurality, and writing only the selected inactive page to the shared storage.

9. The method according to claim 8, wherein providing access to the inactive pages comprises, in response to a request to access one of the inactive pages in the plurality other than the selected inactive page, serving the same content by accessing the selected inactive page.

10. The method according to claim 1, and comprising maintaining a single-bit indication of whether all the memory pages used by the workload have been evicted from the first compute node.

11. The method according to claim 1, wherein evicting the inactive pages comprises producing multiple replicas of at least some of the evicted inactive pages, and storing the replicas on respective different storage devices as part of the shared storage.

12. A computing system, comprising:
at least first and second compute nodes; and
shared storage that is accessible at least to the first and second compute nodes,
wherein the first compute node is configured to run a workload that uses memory pages, to classify the memory pages used by the workload into at least active pages and inactive pages, and to evict the inactive memory pages to the shared storage,
and wherein, in response to migration of the workload from the first compute node to the second compute node, the first and second compute nodes are configured to transfer the active pages from the first compute node to the second compute node for use by the migrated workload, and to provide the migrated workload access to the inactive pages on the shared storage.

13. The system according to claim 12, wherein the workload comprises one of a Virtual Machine (VM) and an operating-system container.

14. The system according to claim 12, wherein a failure domain of the workload consists of a single compute node at all times, except for a time interval following the migration during which the failure domain comprises the first and second compute nodes.

15. The system according to claim 12, wherein the first compute node is configured to run a process that evicts at least some of the inactive pages prior to the migration, and, in response to the migration, to identify any remaining inactive pages on the first compute node and to evict the identified inactive pages to the shared storage.

16. The system according to claim 12, wherein the first compute node is configured to evict the inactive pages by writing the inactive pages to a logical volume assigned to the workload a logical volume on the shared storage.

17. The system according to claim 12, wherein the first or the second compute node is configured to maintain a data structure that indicates, for each memory page used by the workload, whether the memory page is valid on the shared storage.

18. The system according to claim 12, wherein the first compute node is configured to detect that multiple workloads on the first compute node use respective inactive pages having a same content, and to write to the shared storage multiple respective copies of the same content for use by the respective workloads.

19. The system according to claim 12, wherein the first compute node is configured to detect that a plurality of the inactive pages used by the workload have a same content, to select one of the inactive pages in the plurality, and to write only the selected inactive page to the shared storage.

20. The system according to claim 19, wherein, in response to a request by the migrated workload to access one of the inactive pages in the plurality other than the selected inactive page, the second compute node is configured to serve the same content by accessing the selected inactive page.

21. The system according to claim 12, wherein the first or the second compute node are configured to maintain a single-bit indication of whether all the memory pages used by the workload have been evicted from the first compute node.

22. The system according to claim 12, wherein the first compute node is configured to produce multiple replicas of at least some of the evicted inactive pages, and to send the replicas for storage on respective different storage devices as part of the shared storage.

23. A computer software product, the product comprising a tangible non-transitory computer-readable medium in which program instructions are stored, which instructions, when read by processors of first and second compute nodes, cause the processors to run on the first compute node a workload that uses memory pages, to classify the memory pages used by the workload into at least active pages and inactive pages, to evict the inactive memory pages to shared storage that is accessible at least to the first and second compute nodes, and, in response to migration of the workload from the first compute node to the second compute node, to transfer the active pages from the first compute node to the second compute node for use by the migrated workload, and to provide the migrated workload access to the inactive pages on the shared storage.
